(19) United States
(12) Patent Application Publication
(10) Pub. No.: US 2008/0188170 A1
(43) Pub. Date: Aug. 7, 2008

(54) Mobile laminar flow hood

(75) Inventors: Francesco Della Valle, Padova (IT); Michela Rampazzo, Saonara (IT); Vanni Canton, Noventa Padovana (IT)

Correspondence Address: MERCHANT & GOULD PC, P.O. BOX 2903, MINNEAPOLIS, MN, 55402-0903, US

(73) Assignee: EPITECH GROUP S.R.L., Milano (IT)

(21) Appl. No.: 11/703,037

(22) Filed: Feb. 5, 2007

(51) Int. Cl. B08B 15/02

(52) U.S. Cl. 454/62; 454/156

(57) ABSTRACT

The invention relates to an equipment comprising a blower hood suitable to create a laminar flow of sterile air. The equipment further comprises support means for the blower hood. The support means are suitable to provide a stable positioning of the blower hood and a stable adjustment of the direction of the laminar flow.

The present invention relates to a mobile laminar hood, particularly an equipment comprising a blower hood suitable to create a laminar flow of sterile air. The equipment according to the invention comprises a support which allows selecting the position of the hood and the direction of the hood flow.

### TECHNICAL FIELD

In the field of small interventions on patients, which are performed in medical rooms or surgeries, the problem is known to operate with a high level of local sterility, in order to ensure the patient's safety and health.

Unlike in hospital operating rooms, where a high level of overall sterility is required and ensured, in podology, dentistry, otolaryngology, gynaecology, general surgery, veterinary surgeries, etc., and in those rooms where beauty treatments, tattoos, etc. are performed, a high level of sterility may be required in a very narrow working area. This requirement does not justify the very expensive use of those methods and equipment which are normally used in the hospital operating rooms.

In the field of laboratory equipment, blower hoods are known which are suitable to obtain a high level of sterility in a narrow area.

Room air is sucked, microfiltered and blown in the form of a laminar flow on the working area by means of these known hoods.

Microfiltration of the air is carried out by means of HEPA (High Efficiency Particulate Air) filters, the efficiency thereof complies with the EN 1822 standards. More than 99.99% efficiency is typically required for these filters on particles with a diameter as large as 0.3 μm. This high filtering power substantially eliminates the entirety of the contaminants in the air flow.

The laminar flow created by the blower hood consists of a series of threads parallel to each other and all having the same speed. The typical speeds of this kind of flows are about 0.5 m/s. The laminar flow, because of the absence of vortexes, maintains a high separation between what is entrained in the flow and what is outside the same.

Due to microfiltration of air and flow laminarity, these hoods allow a high protection both in the working area which is directly involved in the flow and to the operator outside thereof. By means of these hoods, in fact, mutual and environmental contamination is prevented.

These hoods, however, are not suitable for small operations on patients in the above medical rooms and surgeries.

They are mounted, in fact, on fixed structures, which can be generally accessed only from one side and are closed on the three other sides, such as to form real sterile boxes. The sterile boxes are intended for fixed installation inside the laboratory. They cannot be easily hoisted and allow operating only on samples of definite size, particularly those samples that can be completely introduced in the box.

### OBJECT AND SUMMARY OF THE INVENTION

Accordingly, the object of the present invention is to provide an equipment having such characteristics as to meet the requirements mentioned above, which have not been met in the prior art.

A task of the present invention is to provide an equipment which allows operating on patients under a high level of sterility, and thus in safety.

Another task of the present invention is to provide an equipment capable of creating a sterile working area that can be easily arranged each time in the most suitable position for a particular requirement.

This object and these tasks are achieved by means of an equipment in accordance with claim 1.

### BRIEF DESCRIPTION OF THE DRAWINGS

In order to better understand the present invention and appreciate the advantages of the same, some exemplary embodiments thereof will be described below, with reference to the annexed figures, in which:

FIG. 1 is a side elevational view of an embodiment of the equipment according to the invention;

FIG. 2 are side views of a detail of an equipment similar to that of FIG. 1, in different configurations of use;

FIG. 3 is a perspective view of another embodiment of the equipment according to the invention;

FIG. 4 is a perspective view of an equipment according to the invention similar to that of FIG. 3;

FIG. 5 is a perspective view of an equipment according to the invention similar to that of FIG. 1, in a configuration of use;

FIG. 6 are side views of a further embodiment of the equipment according to the invention, in different configurations of use.

### DETAILED DESCRIPTION OF THE INVENTION

With reference to the annexed figures, an equipment according to the invention is generally designated with reference 1. The equipment according to the invention comprises a blower hood 2 and support means 3 for the blower hood 2.

The blower hood 2, the operating principle thereof being known per se, is suitable to create a laminar flow of sterile air.

In accordance with an embodiment, the blower hood 2 comprises a microfilter, for example a HEPA filter. In accordance with an embodiment, the microfilter has more than 99.99% efficiency on particles having a diameter as large as 0.3 μm. Preferably, the microfilter has more than 99.997% efficiency, such that substantially the entirety of the contaminants in the air flow is eliminated.

In accordance with an embodiment, the blower hood 2 comprises a pre-filter upstream of the HEPA microfilter. This pre-filter can be easily removed and quickly replaced, and provides a longer operating life to the microfilter. In accordance with an embodiment, the pre-filter has 75% efficiency.

In accordance with an embodiment, the blower hood 2 comprises a motor-fan, preferably with low background noise.

In accordance with an embodiment, the blower hood 2 comprises a lighting lamp, for example a fluorescence or incandescence lamp. The lighting lamp is suitable for lightening the work area involved in the laminar flow. Preferably, the lighting lamp is suitable to provide a sufficient light for safe operation.

In accordance with an embodiment, the blower hood 2 further comprises a germicidal lamp, for example an ultraviolet germicidal lamp.

The blower hood 2 is capable of ensuring a high level of sterility in the work area which is directly involved in the laminar flow.

The support means 3 for the blower hood 2 are suitable to allow adjusting the position of the blower hood 2 and adjusting the direction of said laminar flow. At the same time, the support means 3 are suitable to ensure stability both to the position of the blower hood 2 and the direction of the laminar flow.

By “stability” is meant herein and below that the position of the hood and the direction of the flow does not vary accidentally under the effect of the typical loads acting on the hood upon use.

Particularly, the support means 3 are suitable to maintain unchanged the position and direction of the hood under the effect of the hood weight, under the effect of the reaction force originating from the ejection of the air flow, under the effect of the force that the operator has to apply for operating any control located on the hood, etc.

The support means 3 allow the user to position the blower hood 2 as desired within the surgery, medical room or laboratory. The support means 3 further allow arranging the blower hood 2 such that the laminar flow produced by the latter is oriented in the direction required by the operator. Finally, the support means 3 allow holding the blower hood 2 steadily in the desired position and holding the laminar flow steadily in the desired direction.

As it is understood from the description given above, the equipment 1 according to the invention is particularly suited for being used in surgeries, medical rooms or laboratories requiring a high level of sterility in a narrow working area which cannot be established in advance, and that can be arranged in different places.

One possible use of the equipment 1 according to the invention is in surgeries or medical rooms, where small operations are performed on patients which require a high level of local sterility.

Other possible uses of the equipment 1 according to the invention are in laboratories where samples are treated which have such sizes that cannot be introduced in a conventional laminar flow sterile box.

In accordance with an embodiment, the support means 3 comprise a base 30 and a series of rods 31 connected by means of joints 32.

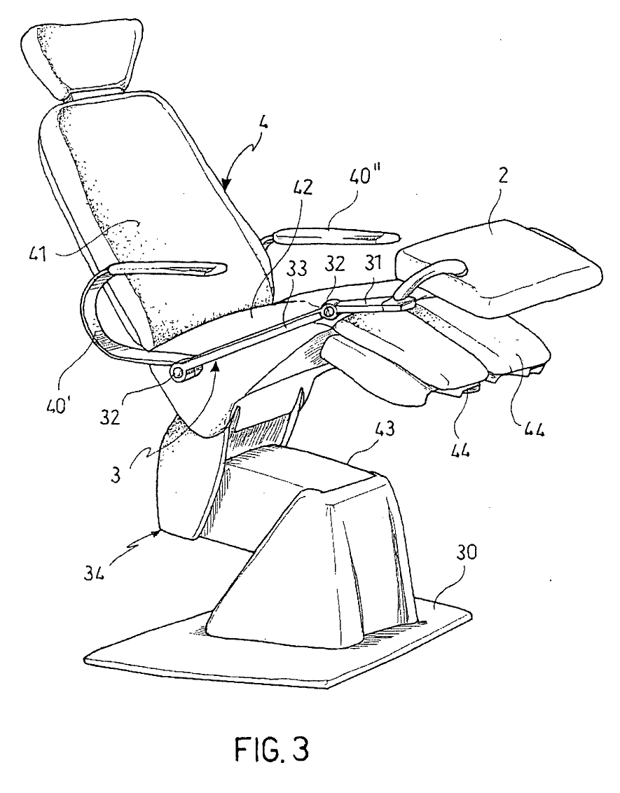

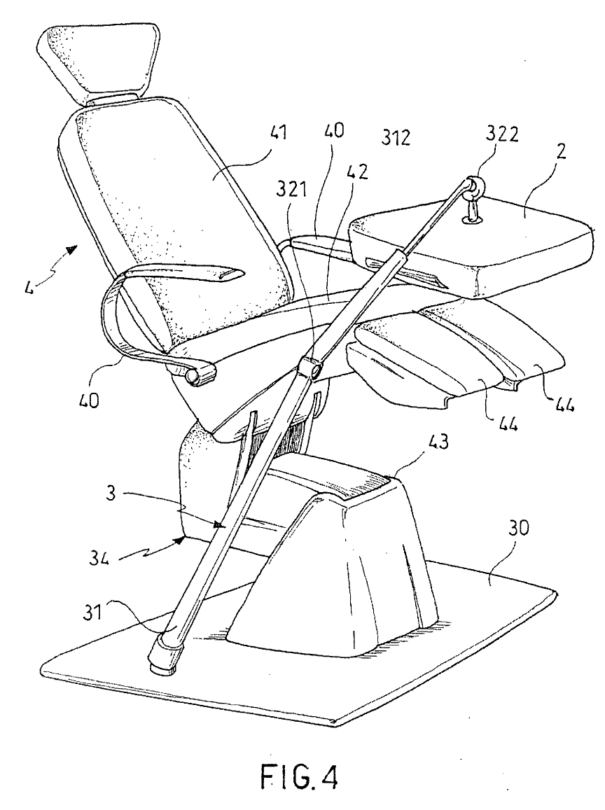

The base 30 is made such that a high stability is ensured for the equipment, for example comprising a wide support surface (see FIGS. 3 and 4), or comprising a ballast or similar anchoring means.

In accordance with an embodiment, the base 30 comprises moving means 301 suitable to provide the base 30 with facility of movement when the equipment 1 is being moved. These means 201 may comprise wheels, rolls, balls, and the like.

In accordance with an embodiment, the base 30 comprises stop means 302 suitable to increase stability and restrain the mobility of the base 30 when the equipment 1 does not require to be moved further. The stop means 302 may for example comprise stops suitable to act on the surface on which the base 30 is moving or brakes suitable to act on the moving means 301, when provided.

The rods 31 and the joints 32 are made such that they provide the blower hood 2 with all the degrees of freedom as deemed necessary for the particular case.

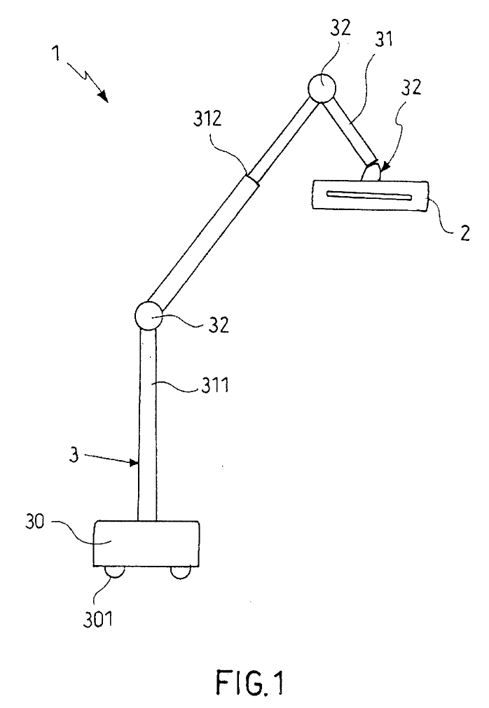

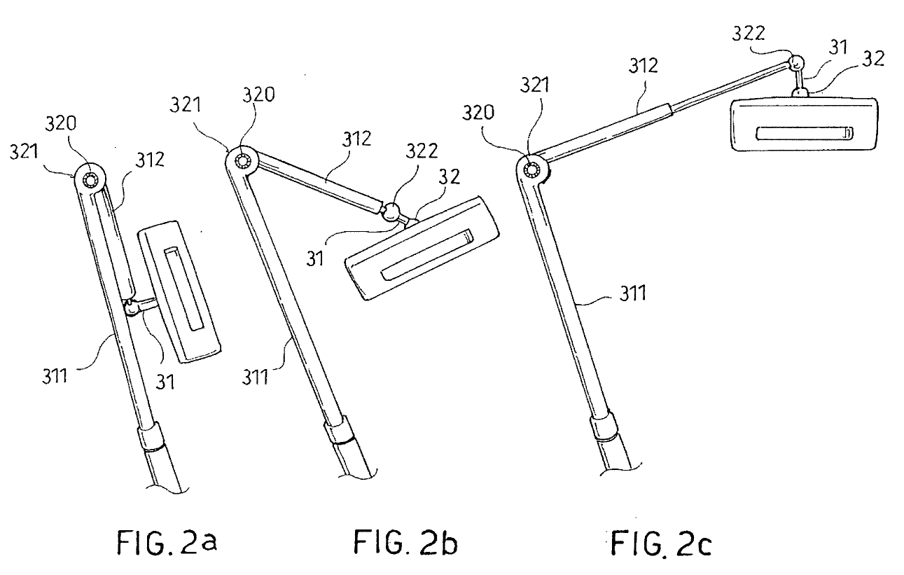

With reference, for example, to FIGS. 1 and 2, a rod 311 of a preset length and a telescopic rod 312 are provided. This solution allows, when the base 30 of the equipment 1 has been fixed, to obtain a translation of the blower hood 2 in the direction of the telescopic rod 312.

With reference, for example, to FIG. 2, a flat hinge joint 321 and a ball hinge joint 322 are used.

The flat hinge joint 321 allows a relative rotation of the two arms connected thereto in the drawing plane about a hinge axis. In other words, the flat hinge joint 321 allows obtaining a rotation of the hood 2 about the axis of the hinge perpendicular to the directions of the two rods connected to the hinge 321.

The ball hinge joint 322, on the other hand, allows the two arms connected thereto to relatively rotate in the space, about a hinge center. In other words, the ball hinge joint 322 allows obtaining a rotation of the hood 2 about the center of the hinge.

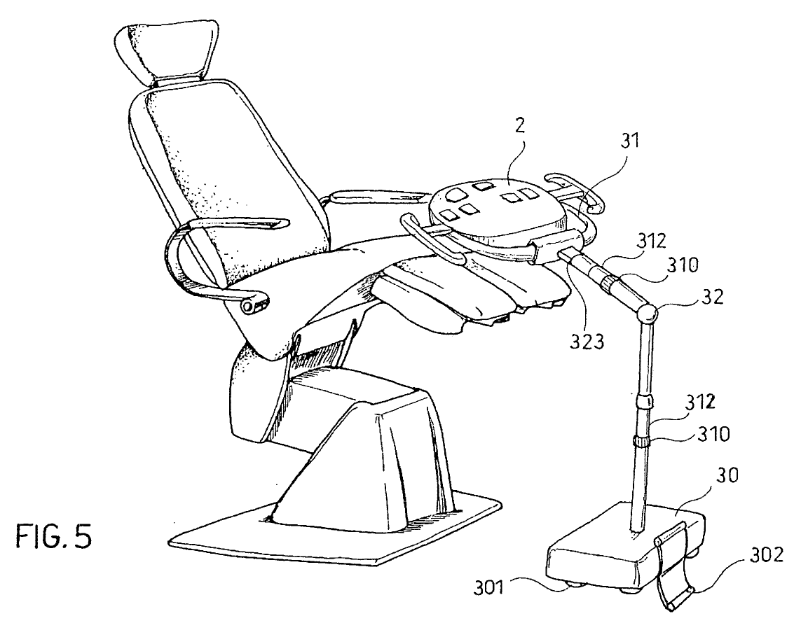

With reference, for example, to FIG. 5, a sleeve coupling 323 is used.

The sleeve coupling 323 allows a rotation about the axis of the rod 31 to which it is connected. In other words, the sleeve coupling 323 allows obtaining a rotation of the hood 2 about the axis of the rod connected to the coupling 323.

As will be appreciated by those skilled in the art, the blower hood 2 that is placed at the end of a chain of rods 31 and joints 32 benefits from the sum of all the degrees of freedom introduced by each of the rods 31 and each of the joints 32.

In accordance with an embodiment, the telescopic rods and the joints comprise means for constantly applying a predetermined counterforce to the movement, such that undesired movement is prevented under the effect of the typical loads acting on the blower hood 2 upon use.

These means may for example comprise systems for obtaining a discrete pitch movement, for example snap systems defining subsequent predefined stable equilibrium positions.

In accordance with another embodiment, the telescopic rods 312 and the hinge joints 32 comprise means for increasing and/or decreasing their resistance to the movement.

These means may for example comprise screw ring nuts like those designated with 310 in FIG. 5 or 320 in FIG. 2.

In accordance with an embodiment, the equipment 1 according to the invention further comprises a furniture element suitable for use in the surgery, medical room or laboratory.

In accordance with an embodiment, this furniture element is an arm-chair or a bed 4 suitable to accommodate a patient. In the particular embodiments illustrated in FIGS. 3 and 4, the arm-chair 4 and the blower hood 2 share the base 30.

Particularly, in the embodiment from FIG. 3, the support means 3 and the arm-chair 4 share the structure 34 which extends from the base 30 to an arm-rest 40.

In the embodiment from FIG. 4, on the other hand, the support means 3 start from base 30, independently from the arm-chair 4.

In these embodiments, the stability of the position of the blower hood 2 benefits from the wide base 30, and the overall mass resting thereon, which makes the blower hood particularly firm. This mass, in fact, comprises the arm-chair mass, and when the equipment 1 is running, the patient's mass.

In the embodiments of the equipment 1 as illustrated in FIGS. 3 and 4, the arm-chair 4 is of the type commonly used in podology surgeries. This type of arm-chair generally comprises patient-moving means. The patient-moving means may for example comprise a reclining backrest 41, a swinging seat 42, a mechanism suitable to lift the entire arm-chair 4. The arm-chair as illustrated in FIGS. 3 and 4 further comprises two leg-rests 44 suitable to raise and lower the patient's legs, independently of each other.

In the embodiment from FIG. 3, in which the support means 3 and the arm-chair 4 share a part of the structure, the arm-rest 40′ from which the support means 3 start is stationary relative to the arm-chair. The patient, in fact, cannot approach and leave the arm-chair 4 from the side housing the support means 3. The opposite arm-rest 40″, on the other hand, is movable in order to facilitate the patient to approach and leave the arm-chair.

In accordance with other possible embodiments of the equipment 1 according to the invention, the arm-chair or bed may be of a different type, for example of the type used in the dentistry, otolaryhgology, gynaecology, general surgery, veterinary surgeries, etc.

In accordance with further possible embodiments of the equipment 1 according to the invention, the arm-chair or bed can be of yet another type, for example the type used in those rooms where beauty treatments, tattoos, etc. are performed.

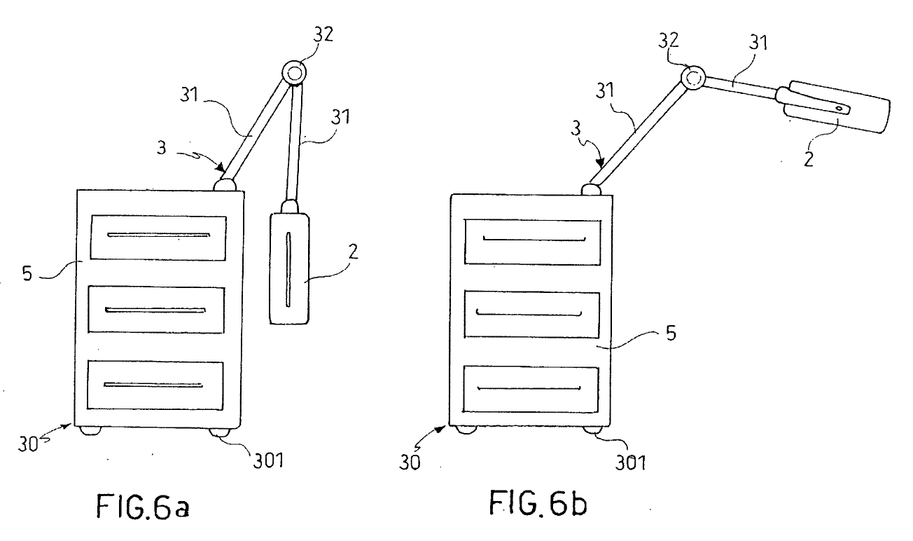

In accordance with the embodiment as shown in FIG. 6, the furniture element comprised in the equipment 1 according to the invention is a cabinet 5, for example provided with drawers and racks to put away the tools used in the surgery, medical room, or laboratory.

This embodiment allows, similarly to FIGS. 3 and 4, using the mass of the furniture element and the tools contained therein for providing stability to the support means 3. Furthermore, as may be seen in FIG. 6a, when the blower hood is not running, the equipment 1 can take a configuration requiring a space just greater than that required by a normal tool cabinet.

As those skilled in the art will appreciate from the above description, the equipment 1 according to the invention allows obtaining a high degree of local sterility, such that operations can be performed on patients under safety conditions.

Furthermore, the equipment 1 according to the invention provides a blower hood 2 that can be easily arranged each time in the most suitable position for the particular requirement, and the laminar flow thereof can be easily arranged each time in the most suitable direction for the particular requirement.

A method of using the equipment 1 is described below in accordance with a further aspect of the invention.

First of all, the operator has to identify the area in the patient's body where he has to operate.

Then, the operator creates the laminar flow of sterile air by means of the blower hood 2.

The operator then selects a position for the blower hood 2 and adjust the direction of the laminar flow such that the laminar flow involves the area in the patient's body which had been previously identified.

The operator then stabilizes the position of the blower hood 2 and the direction of the laminar flow by means of said support means 3.

Finally, the operator can safely operate on the area in the patient's body which had been previously identified.

Obviously, to the equipment 1 according to the present invention, those skilled in the art, aiming at satisfying contingent and specific requirements, may carry out a number of modifications and variations, all being however contemplated within the scope of protection of the invention, such as defined in the annexed claims.

1. An equipment comprising a blower hood suitable to create a laminar flow of sterile air, and support means for said blower hood, characterized in that said support means are suitable to allow adjusting the position of said blower hood and adjusting the direction of said laminar flow and are further suitable to ensure stability to said position and said direction.

2. The equipment according to claim 1, wherein said blower hood comprises a HEPA microfilter.

3. The equipment according to claim 2, wherein said microfilter has more than 99.99% efficiency on particles having a diameter as large as 0.3 μm.

4. The equipment according to claim 2, wherein said blower hood comprises a pre-filter placed upstream of said HEPA microfilter and having about 75% efficiency.

5. The equipment according to claim 1, wherein said blower hood comprises a motor-fan with low background noise.

6. The equipment according to claim 1, wherein said blower hood comprises a lighting lamp.

7. The equipment according to claim 1, wherein said blower hood comprises an ultraviolet germicidal lamp.

8. The equipment according to claim 1, wherein said support means comprise a base and a plurality of rods connected by means of joints.

9. The equipment according to claim 8, wherein said base comprises mobility means suitable to facilitate the movement of the base during a step of moving said equipment.

10. The equipment according to claim 8, further comprising stop means suitable to restrain the mobility of the base after a step of moving said equipment has finished.

11. The equipment according to claim 8, wherein said plurality of rods comprises at least one rod having a preset length.

12. The equipment according to claim 8, wherein said plurality of rods comprises at least one telescopic rod.

13. The equipment according to claim 8, wherein said plurality of joints comprises at least one flat hinge joint.

14. The equipment according to claim 8, wherein said plurality of joints comprises at least one ball hinge joint.

15. The equipment according to claim 8, wherein said plurality of joints comprises at least one sleeve coupling.

16. The equipment according to claim 8, wherein said telescopic rods and said joints comprise means for constantly counter-posing a preset resistance to the movement.

17. The equipment according to claims 8, wherein said telescopic rods and said joints comprise means for increasing and/or decreasing the resistance to the movement.

18. The equipment according to claim 1, further comprising a furniture element.

19. The equipment according to claim 18, wherein said furniture element comprises an arm-chair suitable to accommodate a patient.

20. The equipment according to claim 19, wherein said arm-chair comprises means for moving a patient.

21. The equipment according to claim 19, wherein said arm-chair is of the type commonly used in podology surgeries.

22. The equipment according to claim 18, wherein said furniture element comprises a tool cabinet.

23. The equipment according to claim 18, wherein said furniture element comprises said base.

24. A method for operating on a patient comprising the steps of:
arranging an equipment comprising a blower hood suitable to create a laminar flow of sterile air, and support means for said blower hood suitable to provide a stable positioning of said blower hood and a stable adjustment of the direction of said laminar flow;
identifying the area in the patient's body on which operation is required;
creating a laminar flow of sterile air by means of said blower hood;
selecting a position for said blower hood and adjusting the direction of said laminar flow such that said laminar flow involves said area in the patient's body;
stabilize said position and said direction by means of said support means;
operating on said area on the patient's body.
